(19) United States
(12) Patent Application Publication
(10) Pub. No.: US 2006/0014072 A1
(43) Pub. Date: Jan. 19, 2006

(54) Electrode for fuel cell and process for the preparation thereof

(75) Inventor: Shuji Hitomi, Kyoto (JP)

Correspondence Address: SUGHRUE MION, PLLC, 2100 PENNSYLVANIA AVENUE, N.W., SUITE 800, WASHINGTON, DC, 20037, US

(73) Assignee: JAPAN STORAGE BATTERY CO., LTD.

(21) Appl. No.: 11/229,652

(22) Filed: Sep. 20, 2005

Related U.S. Application Data
(62) Division of application No. 09/822,311, filed on Apr. 2, 2001.

(30) Foreign Application Priority Data
Mar. 31, 2000 (JP) P.2000-097199
Feb. 2, 2001 (JP) P.2001-026447

(51) Int. Cl. H01M 4/86

(52) U.S. Cl. 429/40

(57) ABSTRACT

The present invention provides an electrode for fuel cell comprising a gas diffusion layer comprising porous polymer containing an electro-conductive filler and a catalyst layer containing a particulate catalyst. In this structure, a gas diffusion layer is formed by a porous polymer containing an electro-conductive filler. In this arrangement, the gas diffusion layer can be easily kept in face contact with the interface with the catalyst layer to increase the contact area of the gas diffusion layer with the catalyst layer. Thus, the number of catalyst particles taking part in the transfer of electron, making it possible to raise the output of the fuel cell.

### CROSS REFERENCE TO RELATED APPLICATIONS

This is a divisional of application Ser. No. 09/822,311 filed Apr. 2, 2001; the above noted prior application is hereby incorporated by reference.

### FIELD OF THE INVENTION

The present invention relates to an electrode for fuel cell and a process for the preparation thereof.

### DESCRIPTION OF THE PRIOR ART

A fuel cell (PEFC; a polymer electrolyte fuel cell) is an apparatus which receives hydrogen gas as a fuel in an anode and oxygen gas as an oxidizing agent in a cathode with a cation exchange membrane as a solid polymer electrolyte to cause electrochemical reaction on the surface of a catalyst and hence provide electricity.

By way of example, the electrochemical reaction occurring on the electrodes in the case where hydrogen gas is used as a fuel and oxygen gas is used as an oxidizing agent are shown below.
Anode: H₂→2H⁺+2e⁻
Cathode: 1/2O₂+2H⁺+2e⁻→H₂O
Total reaction: H₂+1/2O₂→H₂O

As shown in the foregoing reaction formula, the reaction on the anode and the cathode require the supply of oxygen and hydrogen gases and the transfer of proton (H⁺) and electron (e⁻). All these reactions proceed only in an area where these requirements can be satisfied.

A schematic diagram illustrating the sectional structure of an electrode for fuel cell of the prior art is shown in FIG. 5. The electrode for fuel cell of the prior art comprises a catalyst layer 51 and a gas diffusion layer 53. The catalyst layer 51 of the electrode for fuel cell is bonded on a cation exchange membrane 54 which is a solid polymer electrolyte. The catalyst layer 51 is a porous layer having catalyst particles and a solid polymer electrolyte distributed three-dimensionally therein in admixture and a plurality of pores formed therein. On the other hand, the gas diffusion layer 52 is a layer containing a porous electro-conductive backbone 53.

In the catalyst layer 51, the catalyst particles form an electron-conductive channel. Further, the solid polymer electrolyte forms a proton-conductive channel. Moreover, oxygen or hydrogen which has been carried to the surface of the catalyst layer 51 is supplied deep into the electrode through the pores formed in the layer 51. The pores also form a discharge channel through which water produced in the depth of the electrode (cathode) is discharged to the surface of the layer 51. In the catalyst layer 51, the foregoing three channels are three-dimensionally distributed to form numerous boundary sites on which the transfer of gases, proton (H⁺) and electron (e⁻) can be conducted at the same time and hence provide a site for electrode reaction.

On the other hand, the gas diffusion layer 52 comprises a porous electro-conductive backbone 53 laminated on the catalyst layer 51 to provide a specific space on the surface of the catalyst layer 51. This space provides a passage through which oxygen and hydrogen as reactants which have been externally supplied are carried to the surface of the catalyst layer 51 and a passage through which water produced in the catalyst layer 51 of the cathode is discharged from the surface layer of the catalyst layer 51 to the exterior of the cell. Further, the transfer of electron (e⁻) between the exterior of the cell and the catalyst layer is effected through the porous electro-conductive backbone 53 as the gas diffusion layer 52. The porous electro-conductive backbone 53 is normally made of a carbon paper which is a sintered nonwoven fabric of carbon fibers having a size of fiber from about 5 to 10 μm. Such a carbon paper has pores normally having an average diameter of from about 20 to 50 μm. On the other hand, the catalyst particles have an average diameter of from 20 to 40 nm. Since the carbon paper has pores having a greater average diameter than that of the catalyst particles, the carbon fibers of the porous electro-conductive backbone 53 come in contact with only some of the catalyst particles even when the porous electro-conductive backbone 53 is bonded to the surface layer of the catalyst layer 51. Accordingly, the catalyst particles in the vicinity of those in contact with the carbon fibers can mainly take part in the transfer of electron while the catalyst particles far from the carbon fibers can hardly take part in the transfer of electron. This makes it impossible for the electrode reaction to proceed uniformly, lowering the percent utilization of catalyst.

### SUMMARY OF THE INVENTION

It is therefore an object of the present invention to provide an electrode for fuel cell comprising a gas diffusion layer 52 which exhibits both highly gas diffusion and electronic conduction properties to have an improved percent utilization of catalyst.

The foregoing object of the present invention will become apparent from the following detailed description and examples.

The electrode for fuel cell according to the invention comprises gas diffusion layer comprising a porous polymer containing an electro-conductive filler and a catalyst layer containing a catalyst particle laminated on each other.

In this structure, the gas diffusion layer is formed by a porous polymer containing an electro-conductive filler. Since a dense and uniform connection can be attained on the area at which the porous polymer comes in contact with the catalyst layer, the contact area of the gas diffusion layer with the catalyst layer can be increased to increase the number of catalyst particles taking part in the transfer of electron, making it possible to enhance the output of the fuel cell. Further, since the polymer has numerous pores acting as feed/discharge channel, through which oxygen and hydrogen as reactants are carried to the surface of the catalyst layer and a passage through which water produced in the catalyst layer of the cathode is discharged to the exterior of the cell can be secured. Moreover, a higher electronic conduction can be attained by the electro-conductive backbone in addition to the electronic conduction attained by the electro-conductive filler.

The process for the preparation of an electrode for fuel cell according to the present invention is characterized by the formation of a gas diffusion layer. In some detail, the gas diffusion layer is formed by a process which comprises dispersing an electro-conductive filler in a solution (1) of a polymer in a solvent to form a dispersion, and then subjecting the dispersion to phase separation of polymer and solvent. One method of causing this phase separation is to bring a liquid which is insoluble for the polymer and is compatible with the solvent into contact with the dispersion, thereby extracting the solvent from the dispersion (solvent extraction method).

In this method, electro-conductive filler is dispersed in a solution (1) of a polymer and its solvent to prepare a dispersion. In this state, the solution (1) has a uniform dissolution. Subsequently, a liquid which is insoluble for the polymer and is compatible with the solvent is allowed to come in contact with the dispersion. In this manner, the solvent of the dispersion is replaced by the liquid. Since the liquid is insoluble for the polymer, its polymer immediately condenses resulting in formation of numerous pores. In other words, the polymer containing the filler condenses with the liquid contained therein. Accordingly, when the liquid is removed from the polymer, a porous polymer is formed. The present invention provides:

(1) An electrode for fuel cell, which comprises:

(a) a catalyst layer comprising catalyst particle; and

(b) a gas diffusion layer comprising a porous polymer containing electro-conductive filler, wherein the gas diffusion layer is on the catalyst layer.

(2) The electrode for fuel cell according to (1), wherein said gas diffusion layer further comprises an electro-conductive backbone in which said porous polymer is applied.

(3) The electrode for fuel cell according to (2), wherein said electro-conductive backbone comprises an aggregate of carbon fibers.

(4) The electrode for fuel cell according to (2), wherein said electro-conductive filler comprises a chopped carbon fiber.

(5) The electrode for fuel cell according to (2), wherein said electro-conductive filler comprises a carbon particle.

(6) The electrode for fuel cell according to (2), wherein said porous polymer comprises a fluoropolymer.

(7) The electrode for fuel cell according to (2), wherein said fluoropolymer comprises a polyvinylidene fluoride (PVdF).

(8) The electrode for fuel cell according to any one of (1) to (7), wherein said porous polymer has a porosity of from 45% to 95%.

(9) A process for the preparation of an electrode for fuel cell, which comprises:

(a) a step of dispersing an electro-conductive filler in a solution (1) comprising a polymer and its solvent to obtain a dispersion;

(b) a step of subjecting said dispersion to phase separation of the polymer and solvent to form a gas diffusion layer comprising porous polymer containing the filler; and

(c) a step of applying a paste comprising a catalyst particle to said gas diffusion layer.

(10) A process for the preparation of an electrode for fuel cell comprising:

(a) a step of forming a catalyst layer containing a catalyst particle;

(b) a step of dispersing an electro-conductive filler in a solution (1) comprising a polymer and its solvent to obtain a dispersion;

(c) a step of applying the dispersion on said catalyst layer; and

(d) a step of subjecting said dispersion applied to the catalyst layer to phase separation of the polymer and solvent to form a gas diffusion layer comprising porous polymer containing the filler.

(11) A process for the preparation of an electrode for fuel cell comprising:

(a) a step of forming a catalyst layer containing a catalyst particle;

(b) a step of laminating an electro-conductive backbone on said catalyst layer;

(c) a step of dispersing an electro-conductive filler in a solution (1) comprising a polymer and its solvent to obtain a dispersion;

(d) a step of applying the dispersion in said electro-conductive backbone; and

(e) a step of subjecting said dispersion incorporated in said electro-conductive backbone to phase separation of polymer and solvent to cause said electro-conductive backbone containing a porous polymer, wherein the porous polymer contains the electro-conductive filler.

(12) A process for the preparation of an electrode for fuel cell comprising:

(a) a step of dispersing an electro-conductive filler in a solution (1) comprising a polymer and its solvent to obtain a dispersion;

(b) a step of applying the dispersion in an electro-conductive backbone;

(c) a step of subjecting the dispersion incorporated in said electro-conductive backbone to phase separation of the polymer and solvent to cause the electro-conductive backbone containing a porous polymer, wherein the porous polymer contains the electro-conductive filler; and

(d) a step of laminating the electro-conductive backbone containing the porous polymer on a catalyst layer containing a catalyst particle.

(13) The process for the preparation of an electrode for fuel cell according to any one of (9) to (12), wherein said phase separation is accomplished by extracting the solvent from said dispersion by a liquid which is insoluble for the polymer and is compatible with said solvent.

(14) A fuel cell comprising an electrode according to any one of (1) to (7).

(15) The fuel cell comprising an electrode according to (8).

(16) A fuel cell comprising an electrode prepared by the preparation process according to any one of (9) to (12).

(17) A fuel cell comprising an electrode prepared by the preparation process according to (13).

### BRIEF DESCRIPTION OF THE DRAWINGS

By way of example and to make the description more clear, reference is made to the accompanying drawings in which:

FIG. 1 is a schematic diagram illustrating the sectional structure of an electrode for fuel cell according to the invention;

FIG. 2 is a schematic diagram illustrating the sectional structure of another electrode for fuel cell according to the invention;

FIG. 3 is a graph illustrating the relationship between the current density and the output voltage of the fuel cell;

FIG. 4 is a graph illustrating the relationship between the porosity of polymer containing the filler and the current; and

FIG. 5 is a schematic diagram illustrating the sectional structure of a conventional electrode for fuel cell.

### DETAILED DESCRIPTION OF THE INVENTION

Embodiments of the structure of the electrode for fuel cell according to the present invention will be further described hereinafter in connection with the attached drawings.

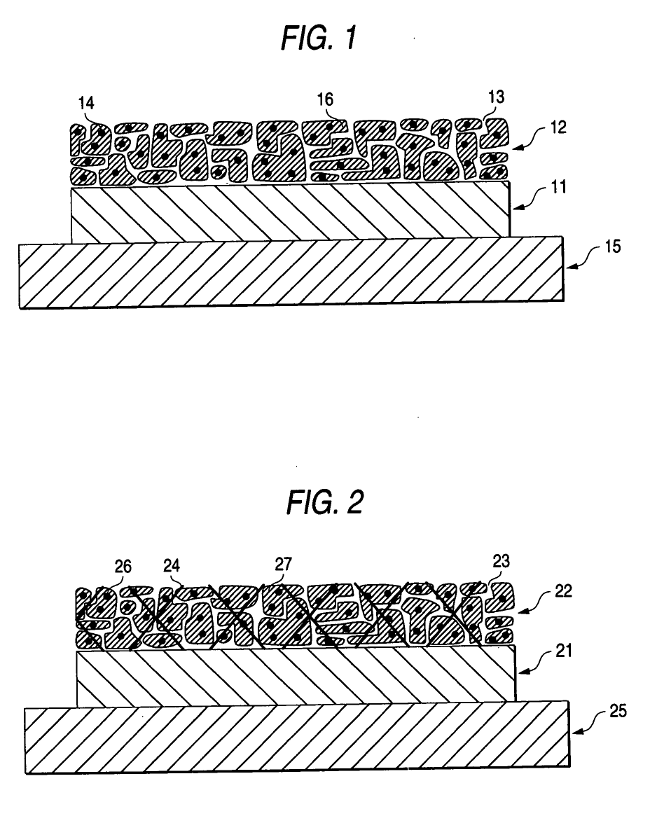

FIG. 1 is a schematic diagram illustrating the sectional structure of an electrode for fuel cell according to the invention. The electrode for fuel cell shown in FIG. 1 comprises a gas diffusion layer 12 formed by a porous polymer 16 containing an electro-conductive filler 14 and a catalyst layer 11 laminated on each other. The porous polymer 16 is dense and uniform and has numerous pores 13 formed therein. The catalyst layer 11 is bonded to a cation exchange membrane 15.

In this arrangement, a gas diffusion layer 12 is formed by the porous polymer 16 containing an electro-conductive filler 14. Since the porous polymer 16 is able to have a dense and uniform connection with the catalyst layer 11, the contact area of the gas diffusion layer 12 with the catalyst layer 11 is increased to increase the number of catalyst particles taking part in the transfer of electron, making it possible to enhance the output of the fuel cell. Further, numerous pores 13 in the porous polymer 16 can provide a passage through which oxygen and hydrogen as active materials are carried to the surface of the catalyst layer 11. Moreover, the numerous pores 13 can provide a passage through which water produced in the catalyst layer 11 of the cathode is discharged to the exterior of the cell.

FIG. 2 is a schematic diagram illustrating the sectional structure of another electrode for fuel cell according to the invention. In the present embodiment of implication of the present invention, the gas diffusion layer 22 further comprises an electro-conductive backbone incorporated therein. Namely, the gas diffusion layer 22 has the electro-conductive backbone 24 containing a porous polymer 27, wherein the porous polymer 27 contains an electro-conductive filler 26. The layer 22 is laid on a catalyst layer 21 containing a catalyst particle. Moreover, the porous polymer 27 has numerous pores 23 formed therein. The catalyst layer 21 is bonded to a cation exchange membrane 25. Accordingly, the gas diffusion layer 22 in the electrode for fuel cell is formed by an electro-conductive backbone 24 in addition to the porous polymer 27 containing the electro-conductive filler 26 and thus exhibits an enhanced electronic conduction.

The porous polymer 27 containing the electro-conductive filler 26 may be distributed all over the electro-conductive backbone 24 as shown in FIG. 2 but may be provided on a part of the electro-conductive backbone 24, e.g., one surface thereof.

The kind of the material of the electro-conductive fillers 14, 26 to be used herein are not specifically limited so far as it is electro-conductive and doesn't react with the electrolyte. For example, a metal such as titanium and stainless steel or carbon may be used. Most preferred among these materials is carbon from the standpoint of handleability or weight. Further, the shape of the electro-conductive fillers 14, 26 to be used herein is not specifically limited. Any shapes such as grain and fiber may be use. Particularly preferred are carbon particle, graphite and activated carbon, and chopped carbon fiber obtained by cutting carbon fibers. A diameter of the chopped carbon fiber is preferably from 5 to 20 μm, and a length of the chopped carbon fiber is preferably from 0.1 to 0.5 mm. Preferred examples of carbon particle include carbon black such as acetylene black and furnace black, graphite particle, and activated carbon. Particularly preferred among these carbons particle is carbon black because of its high electronic conduction. When the porous polymers 16, 27 contain carbon as the filler 14, 26, the amount of carbon to be incorporated therein is preferably 30 wt % or more, more preferably 100 wt % or more for the purpose of providing a higher electronic conduction.

The electro-conductive backbone 24 to be used herein may be made of a foamed nickel or sintered titanium fiber. The material of the electro-conductive backbone 24 is preferably carbon from the standpoint of electrical conductivity, acid resistance, etc. In particular, carbon paper, carbon cloth or carbon felt made of carbon fibers, and a nonwoven fabric of carbon are preferred.

As the catalyst particle for fuel cell of the invention there may be used a particulate catalyst metal such as platinum group metal (e.g., platinum, rhodium, ruthenium, iridium, palladium, osmium) or alloy thereof. A particulate carbon having such a catalyst metal supported thereon (catalyst loaded on carbon) is preferred because it has a high catalytic activity per unit weight of catalyst metal. Preferred examples of particulate carbon include carbon black such as acetylene black and furnace black, and activated carbon. In particular, carbon black is preferred because it allows the carbon metal to be supported thereon to a high degree of dispersion.

The porous polymer 16, 27 containing the electro-conductive fillers 14, 26, respectively, of the invention do not need to have proton-conductivity. For example, polyether such as polyvinyl chloride, polyacrylonitrile, polyethylene oxide and polypropylene oxide, polyacrylonitrile, polyvinylidene fluoride (PVdF), polyvinylidene chloride, polymethyl methacrylate, polymethyl acrylate, polyvinyl alcohol, polymethacrylonitrile, polyvinyl acetate, polyvinyl pyrrolidone, polyethyleneimine, polybutadiene, polystyrene, polyisoprene, and derivatives thereof may-be used singly or in admixture. Alternatively, a polymer obtained by the copolymerization of various monomers constituting the foregoing polymer may be used. Preferably, a fluoropolymer may be used because it has a high water repellency. Examples of such a fluoropolymer employable herein include fluorine-containing homopolymer such as polyethylene trifluorochloride (PCTFE), polyvinylidene fluoride (PVdF) and vinyl fluoride polymer (PVF), fluorine-containing copolymer such as ethylene-ethylene tetrafluoride copolymer (ETFE), ethylene tetrafluoride-propylene hexafluoride copolymer (EPE) and vinylidene fluoride copolymer, and mixture thereof. Particularly preferred among these polymer are polyvinylidene fluoride (PVdF), and copolymer thereof, e.g., polyvinylidene fluoride (PVdF) such as vinylidene fluoride-propylene hexafluoride copolymer (P(VdF-HFP)) and vinylidene fluoride-ethylene tetrafluoride copolymer (P(VdF-TFE)) because they are inexpensive and provide a high water repellency. In particular, vinylidene fluoride (PVdF) or P(VdF-HFP) is preferred.

In the present invention, the catalyst layers 11, 21 contain a particulate catalyst. More preferably, the catalyst layer 11, 21 contains a catalyst particle and a solid polymer electrolyte. As such a solid polymer electrolyte there is preferably used one made of a cation-exchange resin such as perfluorosulfonic acid or styrene-divinylbenzene-based sulfonic acid type cation-exchange resin.

In order to facilitate the supply of the active material and the discharge of water produced in the electrode (cathode), the pores 13, 23 in the porous polymer 16, 27 containing the electro-conductive fillers 14, 26 preferably form dense and continuous three-dimensional network pores. The average diameter of the pores 13, 23 is preferably 2 μm or less, more preferably 1 μm or less. Further, the porosity of the gas diffusion layer containing the porous polymer 16, 27 is preferably from 45% to 95%. When the porosity of the layer falls within the above defined range, a high and uniform electronic conduction and a high gas diffusibility can be provided. The porosity of the gas diffusion layer can be determined according to the following equation:
Porosity/%=100−(100×weight of gas diffusion layer per cm³)/true specific gravity of gas diffusion layer The true specific gravity of the gas diffusion layer can be determined by calculation from true specific gravity and mixing proportion of various materials. The various materials contain a polymer, a filler, and an electro-conductive backbone.

The process for the preparation of the electrode for fuel cell according to the present embodiment of implication of the present invention will be described hereinafter.

Firstly, the process for the preparation of a gas diffusion layer 12 formed by a porous polymer 16 containing an electro-conductive filler 14 will be described.

In some detail, a polymer is dissolved in a solvent to form a solution (1). An electro-conductive filler 14 is then dispersed in the solution (1) to obtain a dispersion. Subsequently, the suspension is subjected to phase separation of polymer and solvent to obtain a porous polymer 16.

In accordance with this process, fine and uniform pores can be obtained particularly when as the porous polymer 16 there is used a fluoropolymer. In other words, a fluoropolymer containing polyvinylidene fluoride (PVdF) such as polyvinylidene fluoride (PVdF), vinylidene fluoride-propylene hexafluoride copolymer (P(VdF-HFP)) and vinylidene fluoride-ethylene tetrafluoride copolymer (P(VdF-TFE)) is suitable for this process. Particularly preferred among these resins are polyvinylidene fluoride (PVdF) and vinylidene fluoride-propylene hexafluoride copolymer (P(VdF-HFP)).

The solvent for dissolving the polymer therein is not specifically limited so far it can dissolve the polymer therein. Examples of the solvent employable herein include dimethylformamide, carbonic acid ester such as propylene carbonate, ethylene carbonate, dimethyl carbonate, diethyl carbonate and ethyl methyl carbonate, ether such as dimethyl ether, diethyl ether and ethyl methyl ether and tetrahydrofuran (THF), dimethylacetamide, 1-methyl-pyrrolidone, and N-methyl-pyrrolidone (NMP).

Examples of the method for phase separation of polymer and solvent employable herein include a method involving the utilization of the change of solubility of the polymer in the solvent with the rise or fall of temperature caused by heating or cooling the dispersion having an electro-conductive filler 14 dispersed therein, and a method involving the utilization of the change of concentration of polymer in the solution (1) with the evaporation of solvent. The method involving the utilization of the change of solubility of the polymer in the solvent with the rise or fall of temperature can be employed for the combination of a polymer and a solvent in which the polymer can hardly be dissolved at low temperatures but can be easily dissolved at raised temperatures. In this method, the temperature is raised to dissolve the polymer completely in the solvent. An electro-conductive filler is then dispersed in the solution (1) of the polymer and solvent. Subsequently, the temperature of the solution is suddenly lowered. As a result, the polymer reaches supersaturation with respect to the solvent so that the polymer and the solvent undergo phase separation in the solution (1). By removing the solvent from the solution (1) having phase-separated polymer and solvent, a porous polymer can be obtained. In this method, as the polymer there is preferably used a polyvinylidene fluoride (PVdF) or P(VdF-HFP). As the solvent for dissolving the resin therein there is preferably used a ketone, particularly methyl ethyl ketone (MEK).

As another method for phase separating of the polymer and the solvent there may be used a method which comprises allowing a liquid in which the polymer is insoluble and is compatible with the solvent to come in contact with the surface of the dispersion to extract the solvent from the dispersion. This method can provide the porous polymer 16 with dense and continuous three-dimensional network pores and thus is mostly desirable in methods for phase separation of polymer and solvent. As the liquid there is preferably used water or a mixture of water and alcohol because it is inexpensive. A mixture of water and alcohol is particularly preferred when the porosity of the porous polymer 16 is preferably reduced.

In this process, the solvent of the dispersion is replaced by the liquid. Since the liquid is compatible with the polymer, it immediately condenses resulting in formation of numerous pores (13). In other words, the polymer containing the filler condenses with the liquid contained therein. Accordingly, when the liquid is removed from the polymer, a porous polymer (16) is formed.

In this method, as the polymer there is preferably used a polyvinylidene fluoride (PVdF) or P(VdF-HFP). In this case, as the solvent for dissolving the polymer therein there is preferably used N-methylpyrrolidone (NMP) and the liquid is preferably used water or a mixture of water and alcohol, respectively, from the standpoint of water repellency, uniformity in pore diameter, etc.

The electrode for fuel cell according to the present embodiment of implication of the present invention can be obtained by a process which comprises forming a catalyst layer 11, and then forming a gas diffusion layer 12 comprising a porous polymer 16 containing an electro-conductive filler 14 thereon or a process which comprises forming a gas diffusion layer 12, and then forming a catalyst layer 11 thereon.

In order to form the gas diffusion layer 12 comprising porous polymer 16 containing an electro-conductive filler 14 after the formation of the catalyst layer 11, a dispersion having an electro-conductive filler 14 dispersed in a solution (1) of a polymer in a solvent is applied on the catalyst layer 11. The application of the dispersion is carried out by means of a brush or spray, or by screen printing method, doctor blade coating method or the like. The dispersion thus applied is then subjected to phase separation of polymer and solvent to prepare an electrode for fuel cell.

The process for the formation of the catalyst layer 11 after the formation of the gas diffusion layer 12 comprising porous polymer 16 containing the electro-conductive filler 14 will be described hereinafter. In some detail, a dispersion having an electro-conductive filler 14 dispersed in a solution (1) of a polymer and its solvent is applied on a polymer film such as PTFE and FEP to form into film shape of the dispersion. The application of the dispersion is carried out by means of a brush or spray, or by screen printing method, doctor blade coating method or the like. The dispersion thus applied is then subjected to separation of polymer and solvent to form a gas diffusion layer 12. Subsequently, the catalyst layer 11 is formed on the surface of the gas diffusion layer 12. Finally, the polymer film is peeled off from the electrode for fuel cell thus formed.

The process for the preparation of the electrode for fuel cell wherein the gas diffusion layer 22 comprising porous polymer containing the electro-conductive filler 26 further comprises an electro-conductive backbone 24 will be described hereinafter.

In some detail, an electro-conductive backbone 24 is laminated on a catalyst layer 21 by hot press or the like. A dispersion of a polymer and an electro-conductive filler 26 is then applied to the electro-conductive backbone 24 by means of a brush or spray, or by screen printing method, doctor blade coating method or the like. Thus, the dispersion is contained in the pores in the electro-conductive backbone 24. Subsequently, the dispersion is subjected to phase separation of polymer and solvent, causing the pores in the electro-conductive backbone 24 containing the porous polymer 27, wherein the porous polymer 27 contains an electro-conductive filler 26. As the method for separating and removing the solvent from the polymer in solution (1) there may be used the same method as the method for the preparation of the gas diffusion layer 12 containing an electro-conductive filler 14. Alternatively, a method may be employed which comprises causing the pores in the electro-conductive backbone 24 containing the porous polymer 27, wherein porous polymer 27 contains an electro-conductive filler 26 before the lamination of the electro-conductive backbone 24 on the catalyst layer 21, and then laminating the electro-conductive backbone 24 on the catalyst layer 21. In some detail, the dispersion containing an electro-conductive filler 26 is applied to the electro-conductive backbone 24 by means of a brush or spray, or by screen printing method, doctor blade coating method or the like. The polymer and the solvent in the dispersion are then subjected to phase separation. Subsequently, the electro-conductive backbone 24 containing porous polymer may be laminated on the catalyst layer 21 by hot press or the like.

The other process for the preparation of the electrode for fuel cell wherein the gas diffusion layer 22 comprising porous polymer containing the electro-conductive filler 26 further comprises an electro-conductive backbone 24 will be described hereinafter.

A porous polymer 27 containing an electro-conductive filler 26 is formed on catalyst layer 21 on cation exchange membrane, and the electro-conductive backbone 24 was then penetrated to a porous polymer layer 27 by hot pressed to form gas diffusion layer comprising the polymer 27 and backbone 24.

The present invention will be further described in the following examples, but the present invention should not be construed as being limited thereto.

### EXAMPLE 1

7 g of platinum loaded on carbon (produced by Tanaka Kikinzoku Kogyo K.K.; 10V30E: Valcan XC-72 supporting 30 wt % platinum; average particle diameter of carbon: 30 nm; average particle diameter of platinum: 2.4 nm) and 72 g of a solid polymer electrolyte solution (produced by Aldrich Inc.; 5% Nafion solution) were mixed to obtain a paste of electrode catalyst layer. The paste thus obtained was then spray-coated onto both sides of a cation exchange membrane (produced by Du Pont Inc.; Nafion; thickness: about 50 μm) to form a catalyst layer. The amount of platinum on the catalyst layer was adjusted to about 1.0 mg/cm² by controlling the amount of platinum loaded on carbon during the preparation of paste and the coated amount of paste.

Subsequently, a dispersion having chopped carbon fibers mixed and dispersed in 100 g of a solution (1) having a polyvinylidene fluoride (PVdF) in NMP such that the concentration of PVdF reached 20 wt % was applied to the surface of the catalyst layer by doctor blade coating method. This laminate thus obtained was then dipped in water as a liquid for 10 minutes to provide a porous PVdF layer containing carbon fibers on the catalyst layer, and carbon papers was further pushed on each side to obtain membrane-electrode assembly. The assembly thus processed was then combined with a single fuel cell to obtain a cell A.

### EXAMPLE 2

20 g of a carbon particle (Valcan XC-72; average particle diameter: 30 nm) was mixed and dispersed in 100 g of a solution (1) having a polyvinylidene fluoride (PVdF) dissolved therein such that the concentration of PVdF reached 20 wt % to obtained dispersion. A carbon paper as a electro-conductive backbone (thickness: 0.5 mm; average fiber diameter: 10 μm; average pore diameter: 10 pm; porosity: 75%) was impregnated into the dispersion at reduced pressure of 1 Torr, and then dipped in water as a liquid for 10 minutes to obtain a gas diffusion layer comprising an electro-conductive backbone provided with a porous PVdF containing a carbon particle.

A paste of catalyst layer made of 7 g of platinum loaded on carbon (produced by Tanaka Kikinzoku Kogyo K.K.; 10V30E: Valcan XC-72 supporting 30 wt % platinum; average particle diameter of carbon: 30 nm; average particle diameter of platinum: 2.4 nm) and 72 g of a solid polymer electrolyte solution (produced by Aldrich Inc.; 5% Nafion solution) was then spray-coated onto the foregoing backbone to obtain an electrode for fuel cell. The amount of platinum on the electrode was adjusted to about 1.0 mg/cm² by controlling the amount of platinum loaded on carbon during the preparation of paste and the coated amount of paste.

Subsequently, the electrode thus obtained was connected to both sides of a cation exchange membrane (produced by Du Pont Inc.; Nafion; thickness: about 50 μm) by hot press to membrane-electrode assembly. The assembly was then combined with a single fuel cell to obtain a cell B.

### COMPARATIVE EXAMPLE 1

A carbon paper which had been treated with a PTFE dispersion to become water repellent was prepared as electro-conductive backbone (thickness: 0.5 mm; average fiber diameter: 10 μm; average pore diameter: 10 μm; porosity: 75%). To the backbone thus prepared was then spray-coated a paste of catalyst layer made of 7 g of platinum loaded on carbon (produced by Tanaka Kikinzoku Kogyo K.K.; 10V30E: Valcan XC-72 supporting 30 wt % platinum; average particle diameter of carbon: 30 nm; average particle diameter of platinum: 2.4 nm), 72 g of a solid polymer electrolyte solution (produced by Aldrich Inc.; 5% Nafion solution) to obtain an electrode for fuel cell. The amount of platinum on the electrode was adjusted to about 1.0 mg/cm² by controlling the amount of platinum loaded on carbon during the preparation of paste and the coated amount of paste.

Subsequently, the electrode thus obtained was connected to both sides of a cation exchange membrane by hot press in the same manner as in Example 2 to obtain the membrane-electrode assembly. The assembly thus obtained was then combined with a single fuel cell to obtain a cell C.

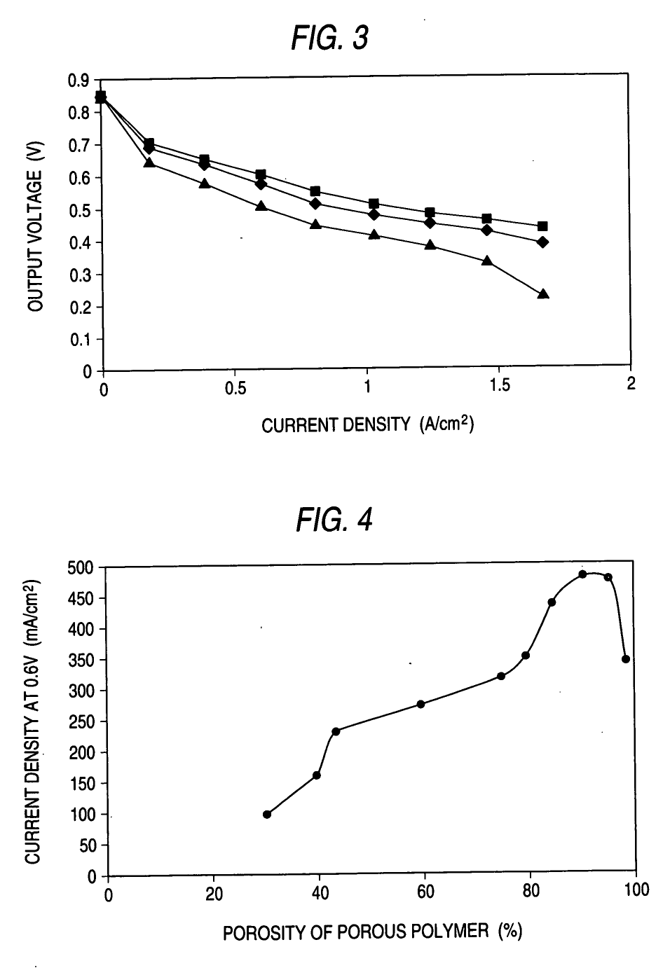

The current-voltage characteristics of the cells A, B and C with oxygen and hydrogen supplied thereinto are shown in FIG. 3. In FIG. 3, the symbols ♦, ▪ and ▴ indicate the characteristics of the cells A, B and C, respectively.

Referring to the operation conditions, these gases (oxygen and hydrogen) were supplied at a pressure of 2 atm. These gases were each blown into water in a sealed tank at 80° C. to become moistened. The cell was operated at 75° C.

As can be seen in FIG. 3, the cells A and B of Examples 1 and 2, respectively, exhibit a higher output voltage at various current densities than the cell C of Comparative Example 1.

These results are attributed to the fact that unlike the cell C, the cells A and B comprise a gas diffusion layer formed by a gas diffusion layer comprising porous polymer containing an electro-conductive filler. In this arrangement, a uniform and dense connection can be easily attained on the area where the gas diffusion layer comes in contact with the catalyst layer. Thus, the contact area of the gas diffusion layer with the catalyst layer is increased to increase the number of catalyst particles taking part in the transfer of electron. Accordingly, the output voltage of the cells A and B are raised.

Further, the cell B, which comprises an electro-conductive backbone incorporated in a porous resin layer, exhibits a higher electronic conduction attained by the electro-conductive backbone in addition to the electronic conduction attained by the electro-conductive filler and thus can provide a greater output voltage than the cell A.

### EXAMPLE 3

In 100 g of a solution (1) having a polyvinylidene fluoride (PVdF) as a polymer dissolved in NMP as a solvent such that the concentration of PVdF reached a range of from 3 to 24 wt % was mixed and dispersed a carbon particle (Valcan XC-72; average particle diameter: 30 nm) in an amount of 50 wt % based on the solid content of PVdF. A carbon paper as a electro-conductive backbone (thickness: 0.5 mm; average fiber diameter: 10 μm; average pore diameter: 10 μm; porosity: 75%) was impregnated in the dispersion at reduced pressure of 1 Torr, and then dipped in water as a solution (1) for 10 minutes to obtain an electro-conductive backbone provided with a porous PVdF containing a carbon particle. The porosity of the backbone with porous polymer containing the filler was determined from the true specific gravity and mixing proportion of the polyvinylidene fluoride (PVdF), carbon particle and carbon backbone and weight of gas diffusion layer per cm³.

Subsequently, onto the foregoing backbone was then spray-coated a paste of electrode catalyst layer made of 7 g of platinum-supported carbon (produced by Tanaka Kikinzoku Kogyo K.K.; 10V30E: Valcan XC-72 suppoting 30 wt % platinum; average particle diameter of carbon: 30 nm; average particle diameter of platinum: 2.4 nm) and 72 g of a solid polymer electrolyte solution (produced by Aldrich Inc.; 5% Nafion solution) to obtain an electrode for fuel cell. The amount of platinum on the electrode was adjusted to about 0.2 mg/cm² by controlling the amount of platinum-supported carbon during the preparation of paste and the coated amount of paste.

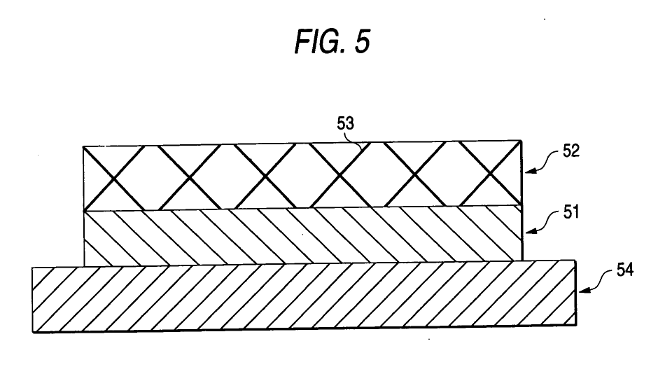

Subsequently, the electrode thus prepared was connected to both sides of a cation exchange membrane (produced by Du Pont Inc.; Nafion; thickness: about 50 μm) by hot press (140° C.) to obtain membrane-electrode assembly. The assembly thus obtained was then combined with a single fuel cell to obtain a cell. Referring to the operating conditions, as gases to be supplied there were used oxygen and hydrogen. These gases were supplied at atmospheric pressure. These gases were blown in water in a sealed tank at 90° C. to become moistened. The cell was operated at 85° C. The relationship between the porosity of gas diffusion layer comprising the backbone with both porous polymer and filler and the current at a cell voltage of 0.6 V is shown in FIG. 4.

As can be seen in FIG. 4, the current shows a high value when the porosity of gas diffusion layer is from 45% to 95%, particularly from 85% to 95%.

While the invention has been described in detail and with reference to specific embodiments thereof, it will be apparent to one skilled in the art that various changes and modifications can be made therein without departing from the spirit and scope thereof.

This application is based on Japanese Patent application No. 2000-097199 filed on Mar. 31, 2000 and Japanese Patent application No. 2001-26447 filed on Feb. 2, 2001, the entire contents of which are incorporated hereinto by reference.

What is claimed is:

1. A process for the preparation of an electrode for fuel cell, which comprises:
preparing an electrode comprising a catalyst layer and a gas diffusion layer;
mixing a polymer, its solvent and an electro-conductive filler to obtain a mixture thereof; and
subjecting said mixture to phase separation of said polymer and said solvent to form said gas diffusion layer comprising porous polymer containing said electro-conductive filler.

2. The process for the preparation of an electrode for fuel cell according to claim 1, which comprises forming said catalyst layer on said gas diffusion layer.

3. The process for the preparation of an electrode for fuel cell according to claim 1, which comprises forming said gas diffusion layer on said catalyst layer.

4. The process for the preparation of an electrode for fuel cell according to claim 3, which comprises:
applying said mixture to said catalyst layer; and
then subjecting said mixture to phase separation of said polymer and said solvent.

5. The process for the preparation of an electrode for fuel cell according to claim 1, which comprises:
laminating an electro-conductive backbone on said catalyst layer;
incorporating said mixture in said electro-conductive backbone; and
subjecting said mixture incorporated in said electro-conductive backbone to phase separation of said polymer and said solvent to cause said electro-conductive backbone to contain said porous polymer therein.

6. The process for the preparation of an electrode for fuel cell according to claim 5, which comprises:
causing said electro-conductive backbone to contain said porous polymer; and
then laminating said electro-conductive backbone on said catalyst layer.

7. The process for the preparation of an electrode for fuel cell according to claim 5, which comprises;
laminating said electro-conductive backbone on said catalyst layer; and
then causing said electro-conductive backbone to contain said porous polymer.

8. The process for the preparation of an electrode for fuel cell according to claim 1, wherein said phase separation is carried out by extracting said solvent from said mixture by a liquid in which said polymer is insoluble and is compatible with said solvent.

9. The process for the preparation of an electrode for fuel cell according to claim 8, wherein water is used as said liquid.

10. The process for the preparation of an electrode for fuel cell according to claim 8, wherein a mixture of water and alcohol is used as said liquid.

11. The process for the preparation of an electrode for fuel cell according to claim 2, wherein said phase separation is carried out by extracting said solvent from said mixture by a liquid in which said polymer is insoluble and is compatible with said solvent.

12. The process for the preparation of an electrode for fuel cell according to claim 3, wherein said phase separation is carried out by extracting said solvent from said mixture by a liquid in which said polymer is insoluble and is compatible with said solvent.

13. The process for the preparation of an electrode for fuel cell according to claim 4, wherein said phase separation is carried out by extracting said solvent from said mixture by a liquid in which said polymer is insoluble and is compatible with said solvent.

14. The process for the preparation of an electrode for fuel cell according to claim 5, wherein said phase separation is carried out by extracting said solvent from said mixture by a liquid in which said polymer is insoluble and is compatible with said solvent.

15. The process for the preparation of an electrode for fuel cell according to claim 6, wherein said phase separation is carried out by extracting said solvent from said mixture by a liquid in which said polymer is insoluble and is compatible with said solvent.

16. The process for the preparation of an electrode for fuel cell according to claim 7, wherein said phase separation is carried out by extracting said solvent from said mixture by a liquid in which said polymer is insoluble and is compatible with said solvent.

17. The process for the preparation of an electrode for fuel cell according to claim 1, wherein said electro-conductive filler is carbon.

18. The process for the preparation of an electrode for fuel cell according to claim 17, wherein said electro-conductive filler is carbon black.

19. The process for the preparation of an electrode for fuel cell according to claim 1, wherein said polymer is fluoropolymer.

20. The process for the preparation of an electrode for fuel cell according to claim 19, wherein said polymer is PVdF or P(VdF-HFP).
